(19) United States
(12) Patent Application Publication
(10) Pub. No.: US 2016/0232461 A1
(43) Pub. Date: Aug. 11, 2016

(54) SYSTEM AND METHOD FOR DETERMINING FORECAST ERRORS FOR MERCHANDISE IN RETAIL

(71) Applicant: ORACLE INTERNATIONAL CORPORATION, Redwood Shores, CA (US)

(72) Inventors: Catalin POPESCU, Atlanta, GA (US); Lin HE, Johns Creek, GA (US); Ming LEI, Lutherville-Timonium, MD (US)

(21) Appl. No.: 14/616,879

(22) Filed: Feb. 9, 2015

(51) Int. Cl. G06Q 10/04; G06Q 30/02

(52) U.S. Cl. CPC G06Q 10/04; G06Q 30/0202

(57) ABSTRACT

Systems, methods, and other embodiments that are associated with a computing device configured to execute a computer application, for providing a determination of retail item demand volatility, are described. In one embodiment, a historical error value is generated, at a class level, representing an uncertainty in a demand for a class of retail items. A scaling value is generated, at a retail item level, representing a variability in a demand for at least one retail item in the class of retail items. A forecast error value is generated representing an uncertainty in the demand for the at least one retail item by combining at least the scaling value for the at least one retail item and the historical error value for the class.

### BACKGROUND

A retail business needs to manage its supply chain of products. In one aspect, computer applications are used to forecast demand of products (e.g., sales and related inventory) to predict which products and how much products should be purchased. Forecasting demand is a big part of managing a retail business and is a key driver of the supply chain. However, no forecast is perfect. To account for fluctuations in demand, replenishment systems use a measure of forecast error to determine the amount of safety stock to be added to an order. Without taking into account safety stock, a retailer may experience increased lost sales because the product is not available for customers who want to buy the product.

Estimating forecast error has been accomplished by two common approaches. A first approach calculates a measure of error based on actual sales and historical forecasts. However, the models used to generate the historical forecasts are typically different than the models used to generate the current forecast. As a result, the forecast and the forecast error come from different sources and thus do not correlate properly. This can lead to over or under estimation of the forecast error, which drives excessive or too little safety stock. Excessive safety stock leads to high inventory levels and cost. Too little safety stock leads to lost sales.

A second approach assumes that many items share the same variability in demand, which is often not the case. For example, a white T-shirt that is sold year-round, and has a predictable demand, will have a smaller variability than a pink T-shirt with a flower design, which is highly seasonal and has a limited lifecycle. Even the same item in different geographies will have very different demand variability. For example, the demand for ice cream in the southern part of the United States is much more predictable than the demand in the northern part. Thus, determining errors in a forecast for a product has been difficult and unreliable.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with an error tool for determining errors in a forecast;

FIG. 2 illustrates one embodiment of a method, performed by the error tool of the computer system of FIG. 1, for forecasting retail demand error;

FIG. 3 illustrates one example embodiment of a table of historical demand data for several retail items in a class of retail items;

FIG. 4 illustrates one example embodiment of a graph of the historical demand data of the table of FIG. 3 showing how the demand streams of the several retail items are very different with respect to variability;

FIG. 5 illustrates example embodiments of several tables of data derived from the historical retail data of the table of FIG. 3 that show how to determine a forecast error value for each of the several retail items in the class of retail items; and

FIG. 6 illustrates one example embodiment of a computing device upon which an error tool of a computing system may be implemented.

### DETAILED DESCRIPTION

Systems, methods, and other embodiments associated with a computer system are disclosed for determining errors in forecasts for product demand. Example embodiments are discussed herein with respect to computerized retail demand error forecasting, where uncertainty in demand is determined, for example, for a retail item and store in a region. In one embodiment, an error tool is disclosed that is configured to determine forecast error values for retail items in a class of retail items. Managing merchandise to mitigate the negative impact of demand volatility on demand forecasting is the challenge being addressed.

The following terms are used herein with respect to various embodiments. In accordance with one embodiment, the terms may be represented as values stored and manipulated in a data structure within a computing system.

The term “for sale”, as used herein, refers to retail items held in inventory that are available for purchase.

The term “demand”, as used herein, refers to sales of a retail item, either actual or predicted.

The term “retail item”, as used herein, refers to merchandise sold, purchased, and/or returned in a retail environment.

The term “retail calendar”, as used herein, refers to a calendar that is used by retailers which is organized into accounting periods (e.g., quarters) for a retail year which can be made to correspond to the same periods for subsequent years, providing an invaluable forecast tool for management. For example, a retail calendar year may have 52 retail periods where each retail period corresponds to a 7-day week. A retail calendar is in electronic form as part of a retail calendar computer application, for example.

The term “retail period”, as used herein, refers to a unit increment of time (e.g., a 7-day week) which retailers use to correlate seasonal retail periods from one year to the next in a retail calendar for the purposes of planning and forecasting. The terms “retail period” and “calendar period” may be used interchangeably herein. A retail period may be in the past (i.e., a historical retail period), in the future (i.e., a future retail period), or in the present (i.e., a current retail period).

The term “retail location”, as used herein, may refer to a physical store where a retail item is sold, or to an on-line store via which a retail item is sold.

The term “historical demand data”, as used herein, refers to sales that have been recorded for a retail item, associated with past retail periods.

The term “retail item level”, as used herein, refers to a lower classification of retail items for individual retail items at one or more retail locations.

The term “class level”, as used herein, refers to a higher classification of retail items for a group of retail items at one or more retail locations.

The term “class of retail items”, as used herein, refers to a group of retail items that are different at the retail item level but are similar to each other in some way at a higher class level. Retail items may be categorized into the same group or class and may be sold across multiple retail locations in a region. For example, quartz wrist watches, mechanical wrist watches, and digital wrist watches sold in the region of San Francisco, Calif. are retail items that belong to the same class known as wrist watches in San Francisco, Calif. Also, cheeses, milk, and eggs are retail items that belong to the same class known as dairy.

The term “backcast”, as used herein, refers to estimates of demand for past retail periods that are made going backwards in time using a current demand forecast model for predicting future demand.

The term “safety stock”, as used herein, refers to an extra amount of a retail item that is purchased to account for demand variability of the retail item.

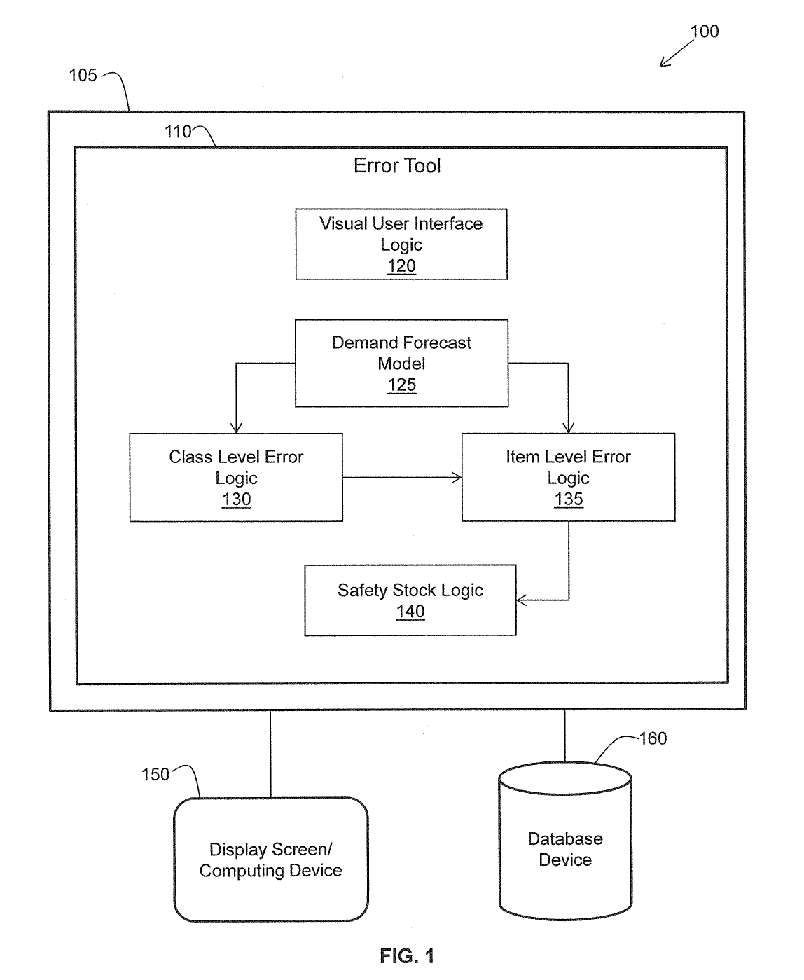

FIG. 1 illustrates one embodiment of a computer system 100, having a computing device 105 configured with an error tool 110. For example, in one embodiment, the error tool 110 may be implemented as a component or part of a larger application such as, for example, an inventory management computer application of a retail company, configured to forecast and manage sales and returns for retail items at one or more retail locations. In another embodiment, the error tool 110 may stand alone as its own application.

In one embodiment, the inventory management computer application may include the error tool 110 having forecasting and management software that computerizes the process for determining uncertainty in demand for retail items. In one embodiment, the software and computing device 105 may be configured to operate with or be implemented as a cloud-based networking system, a software-as-a-service (SaaS) architecture, or other type of computing solution.

In one embodiment, demand variability is determined at a higher level in the product and location hierarchies, where the demand pattern is relatively stable. Actual sales are compared to the backcast to estimate demand error. The backcast and current forecast are generated using the same model. The high level (e.g., class level) error is not simply replicated down at the item/store level (i.e., retail item level) where it is consumed by a demand replenishment system (e.g., a software application implemented on a computer) that is used to determine retail item order quantities. At the retail item level, a profile is created based on the standard deviation of the difference of the retail item level actual sales and backcast. The profile, in combination with the class level forecast error, is used to determine the retail item level forecast error for each retail item, which drives the determination of safety stock for each retail item.

Safety stock is the extra inventory that is purchased to account for fluctuations in demand patterns to make sure that inventory can handle the fluctuations in the demand patterns. When safety stock is overestimated, the retailer may lose money due to inflated inventory costs. When safety stock is underestimated, the retailer may lose money due to lost sales. The forecast error calculations described herein yield improved estimation of forecast error, which in turn determines a more balanced safety stock.

With reference to FIG. 1, in one embodiment, the error tool 110 includes logics for implementing various functional aspects of the error tool 110. In one embodiment, the error tool 110 includes visual user interface logic 120, demand forecast model 125, class level error logic 130, and item level error logic 135. In another embodiment, the error tool 110 also includes safety stock logic 140. In accordance with still another alternative embodiment, the safety stock logic 140 may be implemented in a separate demand replenishment system, for example. The various logics illustrated in FIG. 1 are operably connected to each other within the error tool 110.

The computer system 100 also includes a display screen 150 operably connected to the computing device 105. In accordance with one embodiment, the display screen 150 is implemented to display views of and facilitate user interaction with a graphical user interface (GUI) generated by the visual user interface logic 120 for viewing and updating information associated with inventory management and demand uncertainty. The graphical user interface may be associated with an inventory management computer application and the visual user interface logic 120 may be configured to generate the graphical user interface. In one embodiment, the error tool 110 is a centralized server-side application that is accessed by many users. Thus the display screen 150 may represent multiple computing devices/terminals that allow users to access and receive services from the error tool 110 via networked computer communications.

In one embodiment, the computer system 100 further includes at least one database device 160 operably connected to the computing device 105 or a network interface to access the database device 160 via a network connection. In accordance with one embodiment, the database device 160 is configured to store and manage data structures (e.g., records of historical demand data and forecast error data) associated with the error tool 110 in a database system (e.g., an inventory management application).

Other embodiments may provide different logics or combinations of logics that provide the same or similar functionality as the error tool 110 of FIG. 1. In one embodiment, the error tool 110 is an executable application including algorithms and/or program modules configured to perform the functions of the logics. The application is stored in a non-transitory medium (e.g., memory, storage device, etc).

Referring back to the logics of the error tool 110 of FIG. 1, in one embodiment, the visual user interface logic 120 is configured to generate a graphical user interface to facilitate user interaction with the error tool 110. For example, the visual user interface logic 120 includes program code that generates and causes the graphical user interface to be displayed based on an implemented graphical design of the interface. In response to user actions and selections via the GUI, associated aspects of demand uncertainty and safety stock for retail items may be manipulated.

For example, the visual user interface logic 120 is configured to facilitate inputting of historical demand data, associated with a class of retail items sold at retail locations within a region, into at least one input data structure associated with, for example, an inventory management application via the graphical user interface. Historical demand data includes, for example, actual sales data for the retail items at the class level as well as at the retail item level. The historical demand data may be segmented into retail periods of past weeks, with each past week having numerical values assigned to it to indicate the number of retail items sold for that week, in accordance with one embodiment.

Furthermore, the visual user interface logic 120 is configured to facilitate the outputting and displaying of forecast error data (e.g., numerical forecast error values), via the graphical user interface, on the display screen 150. The displayed forecast error data represents an uncertainty in demand for each retail item in the class of retail items at the retail item level. In one embodiment, item level error logic 135 is configured to operably interact with the visual user interface logic 120 to facilitate displaying of forecast error data of an output data structure.

In one embodiment, the demand forecast model 125 is configured to forecast or predict demand for the retail items over a plurality of future retail periods. The demand forecast model 125 may be, for example, a recently selected model or a newly determined model. However, the demand forecast model 125 may be used to generate backcast data as well. That is, in accordance with one embodiment, the demand forecast model 125 is configured to perform a backcast operation on historical demand data to generate backcast data representing estimated sales of retail items over a plurality of past retail periods.

In this manner, the backcast data may be generated using the same model that is selected to generate a current forecast (i.e., demand for future retail periods). Backcast data may be generated for a class of retail items at the class level and for individual retail items at the retail item level over a plurality of past retail periods. In one embodiment, the class level error logic 130 is configured to generate a historical error value (HEV) based on historical demand data and backcast data at the class level. The HEV represents an uncertainty in demand for a class including a plurality of retail items (i.e., at the class level).

In one embodiment, the item level error logic 135 is configured to generate a scaling value for at least one retail item in a class of retail items at a retail item level based on historical demand data and backcast data at the retail item level. The scaling value for a retail item represents variability in demand for the retail item. The item level error logic 135 is also configured to generate a forecast error value for at least one retail item in a class of retail items at the retail item level based on the scaling value for the retail item and the HEV for the class. The forecast error value represents an uncertainty in demand for the retail item.

In on embodiment, the item level error logic 135 is configured to transform the historical error value (HEV), based at least in part on the scaling value for at least one retail item in the class of retail items, into a forecast error value. Also, in one embodiment, the item level error logic 135 is configured to transform an output data structure by populating the output data structure with at least a forecast error value for at least one retail item in a class of retail items. The item level error logic 135 may also be configured to operably interact with the visual user interface logic 120 to facilitate displaying of at least the forecast error value, of the output data structure, for one or more retail items on the display screen 150 via the graphical user interface.

In accordance with various embodiments, the safety stock logic 140 may be part of the error tool 110, or may be part of another tool or application. The safety stock logic 140 is configured to generate a safety stock value for at least one retail item in a class of retail items at the retail item level based on at least the forecast error value for the retail item. A safety stock value represents an amount of a retail item to be purchased to account for demand variability of the retail item. In accordance with one embodiment, the safety stock logic 140 is configured to transform a forecast error value into a safety stock value for at least one retail item in a class of retail items.

In this manner, an error tool 110 (e.g., implemented as part of an inventory management computer application) can determine forecast error values for retail items representing uncertainty in demand. The forecast error values take into account demand variability at both the class level and the retail item level. As a result, a retailer may use the forecast error values to more accurately determine safety stock.

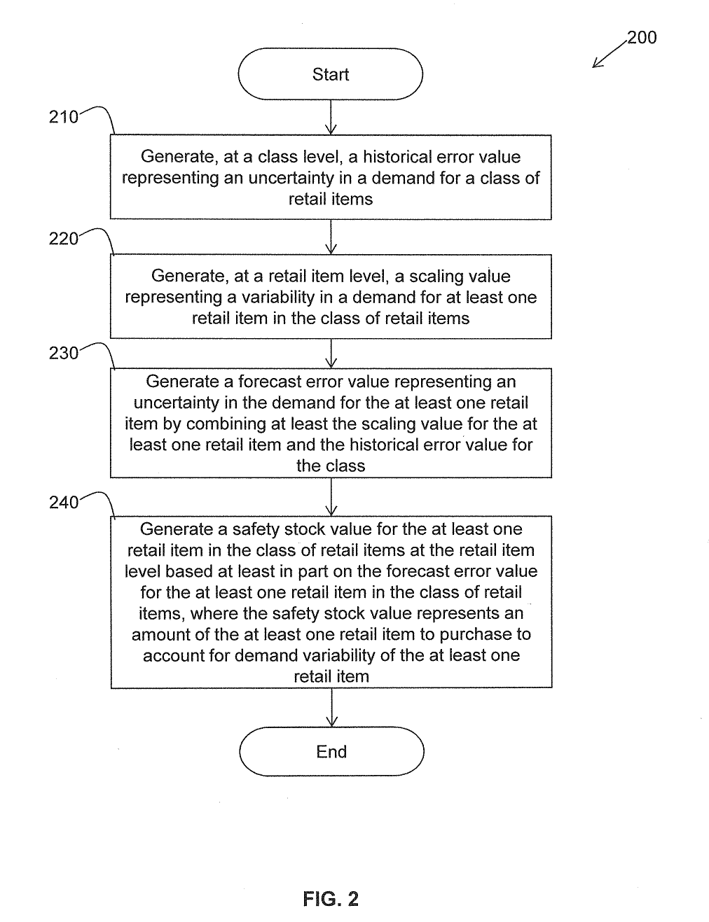

FIG. 2 illustrates one embodiment of a method 200, performed by the error tool 110 of the computer system 100 of FIG. 1, for forecasting retail demand error. Method 200 summarizes the operation of the error tool 110 of FIG. 1 and is implemented to be performed by the error tool 110, or by a computing device configured with an algorithm of the method 200.

Method 200 will be described from the perspective of a class of retail items sold at a plurality of retail locations within a region. A retail location may include a physical store or an on-line store. A retail calendar has many retail periods (e.g., weeks) that are organized in a particular manner (e.g., four (4) thirteen (13) week quarters) over a typical calendar year. A retail period may occur in the past or in the future and may represent, for example, one of a day, a week, a month, or a year, in accordance with various embodiments. Demand for a retail item may fluctuate from retail period to retail period. Method 200 takes into account such fluctuations in demand to allow for a more balanced replenishment of an inventory of a class of retail items.

Upon initiating method 200, at block 210, a historical error value (HEV) is generated, at a class level, which represents an uncertainty in demand for a class of retail items. In accordance with one embodiment, block 210 is performed by the class level error logic 130 of FIG. 1 in cooperation with the demand forecast model 125.

In accordance with one embodiment, to determine the HEV, a demand forecast model 125 is selected for predicting future demand for the class of retail items. The application may have a plurality of demand forecast models from which to select. Historical demand data is read from at least one data structure. The historical demand data represents actual sales of the class of retail items at the class level over a plurality of past retail periods. In accordance with one embodiment, the historical demand data is read from at least one input data structure associated with an inventory management computer application.

The demand forecast model 125 is the forecast model to be used going forward to make predictions of future demand for the retail items. However, it is desirable to use that same demand forecast model 125 to operate on historical demand data, representing past demand, as part of generating forecast error values representing uncertainty in demand for the retail items. In this manner, even though the forecast error values are generated based on past demand data, the forecast error values can be applied to future demand forecasts since the same demand forecast model 125 is being used.

The demand forecast model 125 performs a backcast operation on the historical demand data at the class level to generate backcast data. The backcast data represents estimated sales of the class of retail items over the plurality of past retail periods. In accordance with one embodiment, the backcast data is generated by the demand forecast model 125 operating on the historical demand data. The HEV is generated based on the historical demand data and the backcast data. In accordance with one embodiment, the HEV is generated by the class level error logic 130 operating on the historical demand data and the backcast data. The HEV represents an uncertainty in demand for the class of retail items at the class level.

For example, in one embodiment, when generating the HEV at the class level, a plurality of normalized difference values are calculated. A normalized difference value is calculated for each retail period of the plurality of past retail periods at the class level. Each normalized difference value of the plurality of normalized difference values represents an absolute difference between the historical demand data and the backcast data which is normalized to the historical demand data. Furthermore, in one embodiment, when generating the HEV, the plurality of normalized difference values are summed across the plurality of past retail periods, forming a sum value. Also, the sum value is divided by a number of the plurality of past retail periods to form the HEV at the class level.

For example, the forecast may be calculated at a high level (e.g., at the class level). The forecast captures the robust demand pattern, and is less driven by noise than lower level (retail item level) demand. Once the forecast model is selected, it is used to forecast going back in time (a technique known as backcasting). Given that, for the past, there is actual demand (sales) as well as estimates (backcast values), the historical error value (HEV) may be calculated according to the formula below:

$$HEV = \frac{1}{N} {\sum }_{k = - 1}^{- N} \vert \frac{sales ( k ) - backcast ( k )}{sales ( k )} \vert$$

Note that the formula assumes going back N time periods. N is a parameter that can be adjusted. It is recommended that N is at most one year, such that only more recent data points contribute to the calculation, in accordance with one embodiment. The calculated HEV will be the same for all retail items at the retail item level that map to the class level. To add retail item level variability, the error is combined with the interim forecast standard deviation of the forecast error in the fit region.

At block 220, a scaling value is generated, at the retail item level, for at least one retail item in the class of retail items. The scaling value for a retail item represents variability in demand for the retail item. In accordance with one embodiment, the scaling value is generated for each retail item by the item level error logic 135 in cooperation with the demand forecast model 125. In one embodiment, item level error logic 135 generates a scaling value based on the historical demand data and the backcast data at the retail item level for each retail item in the class of retail items.

In accordance with one embodiment, to determine the scaling value for a retail item, historical demand data is read from at least one data structure. The historical demand data represents actual sales of the class of retail items at the retail item level over the plurality of past retail periods. The demand forecast model 125 performs a backcast operation on the historical demand data at the retail item level to generate backcast data. The backcast data represents estimated sales of at least one the retail item in the class of retail items over the plurality of past retail periods. The scaling value is generated based on the historical demand data and the backcast data.

For example, in one embodiment, when generating the scaling value for each retail item at the retail item level, a difference value is calculated for each retail period of the plurality of past retail periods for each retail item. Each difference value represents a difference between the historical demand data and the backcast data. A standard deviation value is also calculated for each retail item based on the difference value of each retail period for the plurality of past retail periods. Furthermore, an average standard deviation value is calculated for the class of retail items based on the standard deviation value of each retail item in the class of retail items. The standard deviation value for a retail item is divided by the average standard deviation value to form the scaling value for the retail item in the class of retail items.

As an example, as demand can be very noisy at the retail item level, the forecast is not expected to capture every detail of the demand, but is a good indication of the level of demand. If demand is a combination of level, trend, and seasonality, the forecast will only capture the level. Using the same backcast technique as above, the backcast values can be calculated for each retail item i, and the difference between past demand and backcast may be generated as:

DIFF=(salesᵢ(k)−backcastᵢ(k)), where k is from −1 to −M.

Note that the formula assumes going back M time periods. M is a parameter that can be adjusted. In one embodiment, it is recommended that M is at most one year, such that only more recent data points contribute to the calculation.

The standard deviation of the difference for each retail item i may be calculated as:

σᵢ=standard deviation (DIFFᵢ), over the plurality of past retail periods.

The retail item standard deviations are averaged for all retail items in a given class/region. Therefore, a scaling value for a retail item i is calculated as:

scaling valueᵢ=σᵢ/σ

The term σ is the average of all retail item standard deviations in a certain class.

At block 230, a forecast error value is generated for at least one retail item in the class of retail items at the retail item level. A forecast error value is generated based on the scaling value for the retail item and the HEV for the class. A forecast error value represents an uncertainty in demand for a corresponding retail item. For example, in accordance with one embodiment, a forecast error value is calculated by multiplying the HEV by the scaling value. That is, the HEV is multiplied with the retail item standard deviation, and divided by the average standard deviation. For an individual retail item i, the forecast error is calculated according to:

forecast errorᵢ=HEV*σᵢ/σ

In accordance with one embodiment, the item level error logic 135 generates a forecast error value based on the scaling value for a retail item and the HEV for the class. Furthermore, the item level error logic 135 may be configured to transform at least one output data structure by populating the output data structure with at least the forecast error value for a retail item in the class of retail items.

In this manner, uncertainty in demand for a retail item in a class may be determined which takes into account uncertainty in demand at the class level and variability in demand at the retail item level. As a result, in one embodiment, at block 240, a safety stock value for each retail item in the class of retail items may be generated at the retail item level based on at least the forecast error value for a given retail item. For example, in one embodiment, a safety stock value is a non-linear function of a forecast error value. The safety stock value represents an additional amount of a corresponding retail item to purchase and add to inventory to account for demand variability going forward into the future.

In FIG. 2, block 240 may or may not be a part of method 200, in accordance with various embodiments. For example, in accordance with one embodiment, block 240 may be performed by safety stock logic 140 which is not a part of the error tool 110 but which is, instead, a part of an external replenishment system.

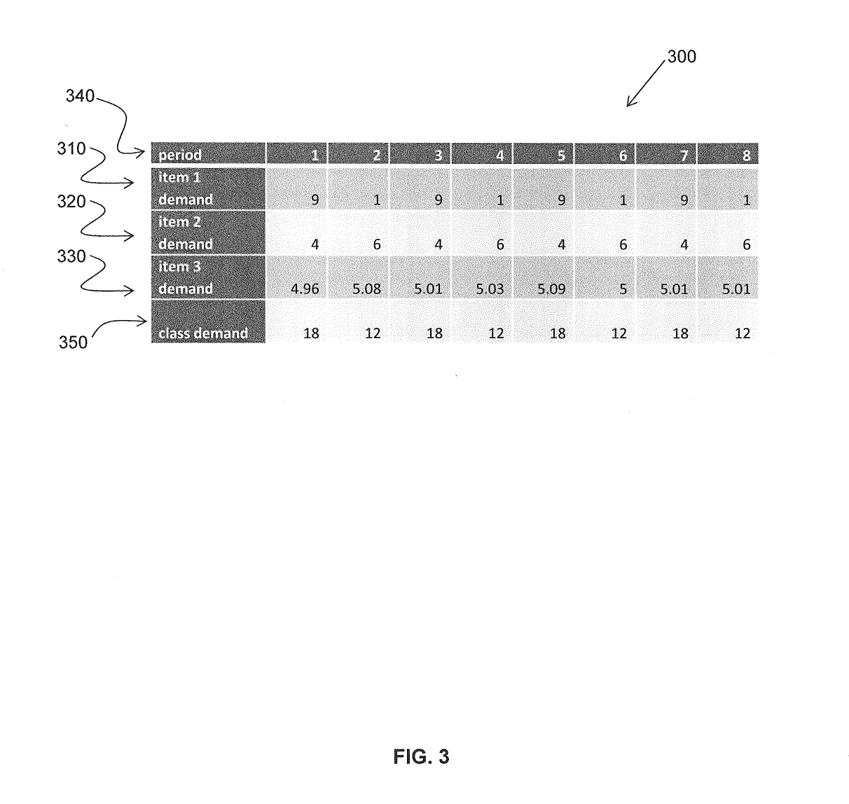

An example of method 200, as implemented by the error tool 110, is described herein below with respect to FIGS. 3-5. FIG. 3 illustrates one example embodiment of a table 300 of historical demand data for several retail items (item 1, item 2, and item 3) in a class of retail items. Each retail item may be, for example, a different brand of television set in a class of television sets (e.g., 52-inch flat screen television sets). Alternatively, each retail item may be, for example, a different type of dairy product (e.g., cheese, eggs, milk) in a class of food products (e.g., dairy products).

Referring to FIG. 3, the table 300 shows demand (actual sales) for the several retail items (i.e., item 1 demand 310, item 2 demand 320, and item 3 demand 330) across eight (8) past retail periods 340. Furthermore, table 300 shows class demand 350 for the class which includes item 1, item 2, and item 3. The class demand is simply the sum of the demands for all three items within a retail period, in accordance with one embodiment.

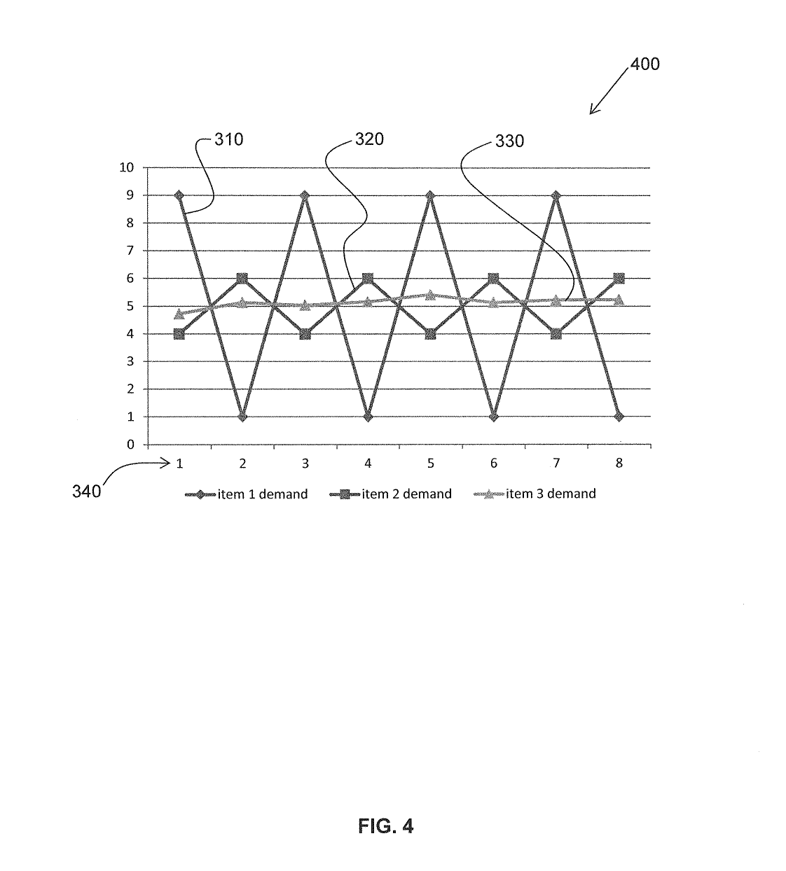

FIG. 4 illustrates one example embodiment of a graph 400 of the historical demand data of the table 300 of FIG. 3, showing how the demand streams of the several retail items are very different with respect to variability over the retail periods 340. The retail periods are represented on the horizontal axis of the graph 400 and demand is represented on the vertical axis of the graph 400.

It is noted, however, that the averages of the demand for all three items are the same, and it is the average that determines the forecast. FIG. 4 shows how just looking at one statistic is not enough in order to characterize the data. Item 1, which is very volatile, needs the most safety stock to account for demand variability. On the other end of the spectrum, item 3 needs a lot less safety stock, if any at all.

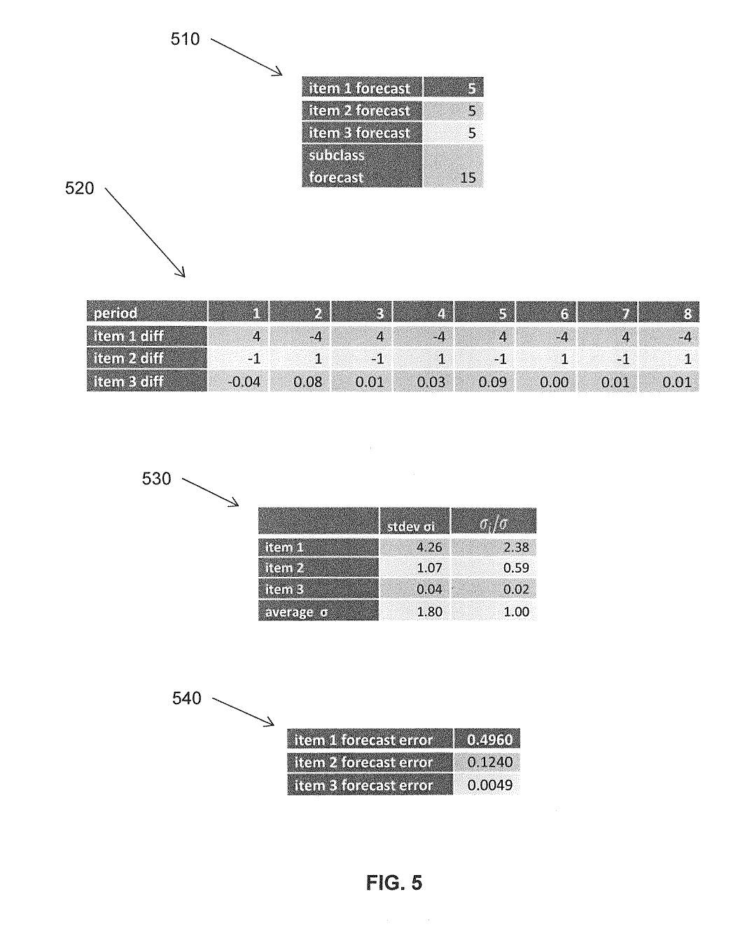

FIG. 5 illustrates example embodiments of several tables of data, derived from the historical retail data of the table 300 of FIG. 3, that show how to determine a forecast error value for each of the several retail items in the class of retail items. For the present example, it is assumed herein that the forecasts of the three items, and of the class, are their average values as shown in table 510 of FIG. 5. Furthermore, for simplicity, it is assumed that the backcast is equal to the forecast going forward (i.e., the same demand forecast model is used for both the forecast and the backcast).

In accordance with one embodiment, the historical error value (HEV) at the class level is calculated as:

$$HEV = \frac{1}{8} {\sum }_{k = - 1}^{- 8} \vert \frac{sales ( k ) - 15}{sales ( k )} \vert = 0.208$$

The HEV is to be applied to all three retail items in the example.

However, to capture the variability introduced by the retail item level demand, the difference between each retail item's demand and forecast is calculated and shown in table 520 of FIG. 5 for each retail period as item 1 diff, item 2 diff, and item 3 diff. Furthermore, the standard deviations σᵢ of the differences over the retail periods and the scaling factors σᵢ/σ are calculated and shown in table 530 of FIG. 5. The forecast error value for each retail item is calculated, and shown in table 540 of FIG. 5, by multiplying the HEV by the scaling factor for each retail item. It is noted herein that the retail item level forecast error values of table 540 reflect the variability of demand as seen in FIG. 4.

Again, the forecast error values may be used to generate a safety stock value for each retail item i as, for example, a function of the forecast error values which may be represented as:

safety stockᵢ=f(forecast error value),

The function f may be linear or non-linear, in accordance with various embodiments. For example, in one embodiment, the amount of safety stock for a retail item is proportional to the square root of the forecast error value.

Systems, methods, and other embodiments that are associated with a computer application configured to execute on a computing device, for providing a determination of retail item demand volatility, have been described. In one embodiment, a historical error value is generated representing an uncertainty in demand for a class of retail items at a class level. A scaling value, representing variability in demand, is generated for at least one retail item in the class at a retail item level. A forecast error value, representing an uncertainty in demand, is generated for the at least one retail item in the class of retail items at the retail item level based on the scaling value for the retail item and the historical error value for the class.

Computing Device Embodiment

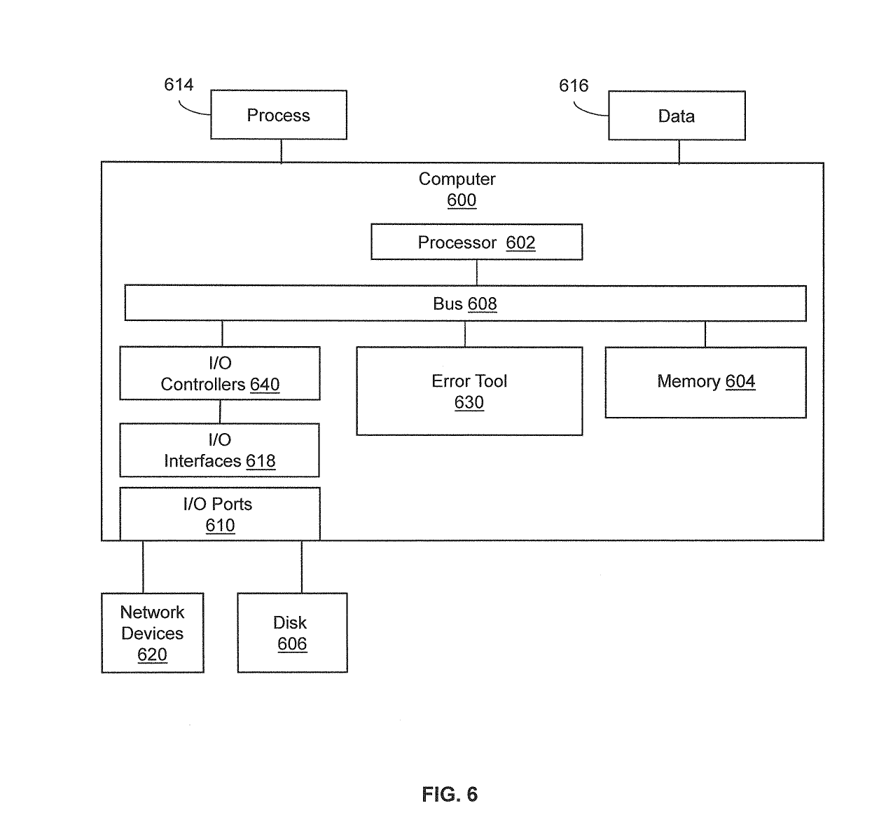

FIG. 6 illustrates an example computing device that is configured and/or programmed with one or more of the example systems and methods described herein, and/or equivalents. FIG. 6 illustrates one example embodiment of a computing device upon which an embodiment of an error tool may be implemented. The example computing device may be a computer 600 that includes a processor 602, a memory 604, and input/output ports 610 operably connected by a bus 608. In one example, the computer 600 may include error tool 630 configured to determine a forecast error value, representing an uncertainty in demand, for at least one retail item in a class of retail items at a retail item level. In different examples, the tool 630 may be implemented in hardware, a non-transitory computer-readable medium with stored instructions, firmware, and/or combinations thereof. While the tool 630 is illustrated as a hardware component attached to the bus 608, it is to be appreciated that in other embodiments, the tool 630 could be implemented in the processor 602, stored in memory 604, or stored in disk 606.

In one embodiment, tool 630 or the computer 600 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the forecasting of safety stock for a retailer. The means may also be implemented as stored computer executable instructions that are presented to computer 600 as data 616 that are temporarily stored in memory 604 and then executed by processor 602.

Tool 630 may also provide means (e.g., hardware, non-transitory computer-readable medium that stores executable instructions, firmware) for facilitating the forecasting of demand error for retail items for a retailer.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM, PROM, and so on. Volatile memory may include, for example, RAM, SRAM, DRAM, and so on.

A storage disk 606 may be operably connected to the computer 600 via, for example, an input/output interface (e.g., card, device) 618 and an input/output port 610. The disk 606 may be, for example, a magnetic disk drive, a solid state disk drive, a floppy disk drive, a tape drive, a Zip drive, a flash memory card, a memory stick, and so on. Furthermore, the disk 606 may be a CD-ROM drive, a CD-R drive, a CD-RW drive, a DVD ROM, and so on. The memory 604 can store a process 614 and/or a data 616, for example. The disk 606 and/or the memory 604 can store an operating system that controls and allocates resources of the computer 600.

The computer 600 may interact with input/output devices via the i/o interfaces 618 and the input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, and USB ports.

The computer 600 can operate in a network environment and thus may be connected to the network devices 620 via the i/o interfaces 618, and/or the i/o ports 610. Through the network devices 620, the computer 600 may interact with a network. Through the network, the computer 600 may be logically connected to remote computers. Networks with which the computer 600 may interact include, but are not limited to, a LAN, a WAN, and other networks.

### DEFINITIONS AND OTHER EMBODIMENTS

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface.

An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, firmware, a non-transitory medium with stored instructions of an executable application or program module, and/or combinations of these to perform any of the functions or actions as disclosed herein, and/or to cause a function or action from another logic, method, and/or system to be performed as disclosed herein. Logic may include a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. Logic is limited to statutory subject matter under 35 U.S.C. §101.

“User”, as used herein, includes but is not limited to one or more persons, computers or other devices, or combinations of these.

“Operable interaction”, as used herein, refers to the logical or communicative cooperation between two or more logics via an operable connection to accomplish a function.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A & B, A & C, B & C, and/or A & B & C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A method implemented by a computing device configured to execute a computer application, wherein the computer application is configured to process data in electronic form, the method comprising:
for a class of retail items that are for sale at one or more retail locations:
generating, at a class level, a historical error value representing an uncertainty in a demand for the class of retail items;
generating, at a retail item level, a scaling value representing a variability in a demand for at least one retail item in the class of retail items; and
generating a forecast error value representing an uncertainty in the demand for the at least one retail item by combining at least the scaling value for the at least one retail item and the historical error value for the class.

2. The method of claim 1, wherein generating, at the class level, the historical error value comprises:
selecting a demand forecast model for the class of retail items for predicting a future demand for the class of retail items;
reading historical demand data from at least one data structure, over a plurality of past retail periods, representing actual sales of the class of retail items at the class level;
performing a backcast operation, using the demand forecast model, on the historical demand data at the class level to generate backcast data representing estimated sales of the class of retail items over the plurality of past retail periods; and
generating the historical error value based at least in part on the historical demand data and the backcast data.

3. The method of claim 2, wherein generating the historical error value comprises:
generating a normalized difference value, for each retail period of the plurality of past retail periods at the class level, forming a plurality of normalized difference values each representing an absolute difference between the historical demand data and the backcast data which is normalized to the historical demand data;
summing the plurality of normalized difference values across the plurality of past retail periods, forming a sum value; and
dividing the sum value by a number of the plurality of past retail periods to form the historical error value at the class level.

4. The method of claim 1, wherein generating, at the retail item level, the scaling value for the at least one retail item in the class of retail items comprises:
selecting a demand forecast model for the class of retail items for predicting a future demand for the class of retail items;
reading historical demand data from at least one data structure, over a plurality of past retail periods, representing actual sales of the class of retail items at the retail item level;
performing a backcast operation, using the demand forecast model, on the historical demand data at the retail item level to generate backcast data representing estimated sales of the at least one retail item in the class of retail items over the plurality of past retail periods; and
generating the scaling value for the at least one retail item in the class of retail items based at least in part on the historical demand data and the backcast data.

5. The method of claim 4, wherein generating the scaling value for the at least one retail item in the class of retail items comprises:
generating a difference value for each retail period of the plurality of past retail periods for each retail item in the class of retail items, representing a difference between the historical demand data and the backcast data;
generating a standard deviation value for each retail item in the class of retail items based at least in part on the difference value of each retail period of the plurality of past retail periods;
generating an average standard deviation value for the class of retail items based on the standard deviation value of each retail item in the class of retail items; and
dividing the standard deviation value for the at least one retail item by the average standard deviation value to form the scaling value for the at least one retail item in the class of retail items.

6. The method of claim 1, further comprising generating a safety stock value for the at least one retail item in the class of retail items at the retail item level based at least in part on the forecast error value for the at least one retail item in the class of retail items, where the safety stock value represents an amount of the at least one retail item to purchase to account for demand variability of the at least one retail item.

7. The method of claim 2, wherein each retail period of the plurality of past retail periods represents one of a day, a week, a month, or a year.

8. The method of claim 4, wherein each retail period of the plurality of past retail period represents one of a day, a week, a month, or a year.

9. The method of claim 1, wherein the one or more retail locations include at least one of a physical store or an on-line store.

10. A computing system, comprising:
class level error logic configured to generate, at a class level, a historical error value representing an uncertainty in a demand for a class including a plurality of retail items; and
item level error logic configured to:
(i) generate a scaling value, at a retail item level, for individual retail items from the plurality of retail items, wherein the scaling value represents a variability in a demand for an associated retail item of the plurality of retail items, and
(ii) generate a forecast error value, at the retail item level, for the individual retail items from the plurality of retail items by combining at least the scaling value and the historical error value, wherein the forecast error value represents an uncertainty in the demand for the associated retail item.

11. The computing system of claim 10, further comprising safety stock logic configured to generate, at the retail item level, a safety stock value for the individual retail items of the plurality of retail items based at least in part on the forecast error value, wherein the safety stock value represents an amount of the associated retail item to purchase to account for demand variability of the associated retail item.

12. The computing system of claim 10, further comprising a demand forecast model configured to:
generate, at the class level, backcast data representing estimated sales of the plurality of retail items over at least one past retail period, and
predict, at the retail item level and the class level, the demand for the plurality of retail items over at least one future retail period.

13. The computing system of claim 10, further comprising visual user interface logic configured to facilitate inputting of historical demand data into one or more data structures, wherein the historical demand data represents actual sales of the plurality of retail items at the class level and the retail item level over at least one past retail period.

14. The computing system of claim 13, further comprising a display screen configured to display and facilitate user interaction with at least a graphical user interface, wherein the visual user interface logic is configured to generate the graphical user interface.

15. The computing system of claim 14, wherein the item level error logic is configured to transform an output data structure by populating the output data structure with at least the forecast error value for the associated retail item.

16. The computing system of claim 15, wherein the item level error logic is configured to operably interact with the visual user interface logic to facilitate displaying of at least the forecast error value for the associated retail item, of the output data structure, on the display screen via the graphical user interface.

17. The computing system of claim 10, further comprising a database device configured to store data structures associated with the computing system.

18. A non-transitory computer-readable medium storing computer-executable instructions that are part of an algorithm that, when executed by a computer, cause the computer to perform a method, wherein the instructions comprise instructions configured for:
generating a historical error value, representing an uncertainty in demand for a class of retail items at a class level, based at least in part on historical demand data and backcast data at the class level;
generating a scaling value, representing a variability in demand for at least one retail item in the class of retail items at a retail item level, based at least in part on historical demand data and backcast data at the retail item level; and
transforming the historical error value, based at least in part on the scaling value for the at least one retail item, into a forecast error value representing an uncertainty in demand for the at least one retail item.

19. The non-transitory computer-readable medium of claim 18, wherein the instructions further include instructions configured for transforming at least one output data structure by populating the at least one output data structure with at least the forecast error value for the at least one retail item.

20. The non-transitory computer-readable medium of claim 18, wherein the instructions further include instructions configured for transforming the forecast error value into a safety stock value for the at least one retail item based at least in part on a function, where the safety stock value represents an amount of the at least one retail item to purchase to account for demand variability of the at least one retail item.
